(19) United States
(12) Patent Application Publication
(10) Pub. No.: US 2013/0026927 A1
(43) Pub. Date: Jan. 31, 2013

(54) ILLUMINATION DEVICE AND ILLUMINATION SYSTEM

(71) Applicant: Hiroto Uhara, Osaka-shi (JP)

(72) Inventor: Hiroto Uhara, Osaka-shi (JP)

(73) Assignee: SHARP KABUSHIKI KAISHA, Osaka-shi, Osaka (JP)

(21) Appl. No.: 13/640,411

(22) PCT Filed: Apr. 11, 2011
(86) PCT No.: PCT/JP2011/059035

§ 371 Date: Oct. 10, 2012

(30) Foreign Application Priority Data
Apr. 12, 2010 (JP) 2010-091380

(51) Int. Cl. H05B 37/02

(52) U.S. Cl. 315/129

(57) ABSTRACT

An illumination device (100) is capable of preventing waste of standby power consumption over a long period of time after it is turned off by operation of a remote control (a remote control device). The illumination device (100) includes: a control section (30) which controls LED modules (42, 43); and a remote control light receiving section (45) which receives a turn-off instruction signal from the remote control device. The control section (30) includes a control microcomputer (35), which turns off the LED modules (42, 43) in response to the turn-off instruction signal received by the remote control light receiving section (45) and, after a certain period of time has passed, causes the LED modules (42, 43) to light up or blink according to a predetermined pattern in order to notify a user that a power supply is in a standby state.

### TECHNICAL FIELD

The present invention relates to an illumination device which includes a light source such as a light-emitting diode. In particular, the present invention relates to an illumination device in the shape of a bulb.

### BACKGROUND ART

Japanese Patent Application Publication, Tokukaihei, No. 11-312591 A (Patent Literature 1) discloses an illumination device which includes (i) a light source such as a fluorescent lamp, (ii) a lighting device such as an inverter for driving the light source, (iii) a microcomputer for controlling the state of the light source by controlling the lighting device, (iv) a receiving section for receiving a signal from a remote control and supplying the signal to the microcomputer and (v) a signal detecting section for detecting the signal from the receiving section.

While the light source is OFF, the illumination device is in a standby state, in which (i) switching means connected to the microcomputer is open so that DC power supplied to the microcomputer is blocked and (ii) the receiving section and the signal detecting section are each supplied with DC power intermittently. When the receiving section transmits the signal to the microcomputer in response to the signal from the remote control, the microcomputer is supplied with a direct current in response to an output signal from the signal detecting section. That is, the switching means serves to block DC power from being supplied to the microcomputer while the light source is OFF. This makes it possible to reduce standby power. Note, however, that the light source of the illumination device of Patent Literature 1 is for example a fluorescent lamp. Therefore, a device (for example, switching means) to dramatically reduce standby power is contained not in a fluorescent tube but in the illumination device separately from the fluorescent tube.

Further, there has been put into practice an illumination device which includes (i) an LED bulb serving as a light source and (ii) a remote control receiver for receiving an operation, on a remote control, of indicating ON/OFF of the light source, which remote control receiver is provided inside the LED bulb.

### CITATION LIST

### Patent Literature

Patent Literature 1
Japanese Patent Application Publication, Tokukaihei, No. 11-312591 A (Publication Date: Nov. 9, 1999)

### SUMMARY OF INVENTION

### Technical Problem

The illumination device described in Patent Literature 1 has the following problem. The device to dramatically reduce standby power cannot be contained in a florescent tube of the light source, and thus is provided separately from the fluorescent tube. Therefore, standby power cannot be reduced for example by merely replacing fluorescent tubes, and thus the entire illumination device needs to be replaced.

On the other hand, consider a case of the illumination device which includes (i) the LED bulb serving as a light source and (ii) the remote control receiver for receiving an operation, on a remote control, of indicating ON/OFF of the light source, which remote controller is provided inside the LED bulb. Such an illumination device requires less electric power to turn on the light source, and its standby power is approximately less than 10 percent of the electric power that it requires to turn on the light source. Therefore, it has been expected that such an illumination device reduces standby power. However, in order for a control section inside the bulb to stop supply of electric power and to further reduce standby power, it is necessary to provide an additional circuit. That is, it is necessary to attach the circuit to the illumination device separately from the bulb.

An object of the present invention is to provide an illumination device and an illumination system in each of which standby power consumption can be reduced by simply replacing bulbs without an increase in the size of the bulbs. This is achieved by arranging the illumination device and the illumination system such that, after a bulb is turned off by an operation of a remote control (remote control device), a user is notified that a power supply is in a standby state so that the user can turn off a main power supply of a wall switch.

### Solution to Problem

An illumination device in accordance with the present invention includes a receiving section for receiving, from a remote control device, a turn-off instruction signal which instructs a light source to be turned off; and a control section for turning off the light source in response to the turn-off instruction signal received by the receiving section and, after a certain period of time has passed, notifying a user that a power supply is in a standby state.

According to these features, it is possible to notify a user, after a certain period of time has passed since the turn-off instruction signal was transmitted from the remote control device and the light source was turned off, that the power supply is in a standby state. Accordingly, the user, who is notified that the standby power is being consumed, is given an opportunity or motivation to turn off a main power supply. As a result, it is possible to prevent unnecessary consumption of standby power.

An illumination system in accordance with the present invention includes: an illumination device; and a remote control device, the illumination device including (i) a receiving section for receiving a turn-off instruction signal from the remote control device and (ii) a control section for turning off the light source in response to the turn-off instruction signal received by the receiving section and, after a certain period of time has passed, notifying a user that a power supply is in a standby state, and the remote control device including switching means provided to retain the standby state of the power supply, and a transmitting section for transmitting, to the receiving section, a retention signal to retain the standby state of the power supply, in response to operation of the switching means.

According to these features, the following is achieved. That is, a user turns off the light source by transmitting the turn-off instruction signal via the remote control device and, after a predetermined period of time, is notified that the power supply is in the standby state. Such a user can retain the standby state of the power supply by operating the switching means of the remote control device. In this way, unnecessary lighting or blinking in a predetermined pattern is stopped. This prevents for example, while a user is sleeping in a bedroom etc., the user's sleep from being disturbed by the light source lighting in a predetermined pattern.

### Advantageous Effects of Invention

According to the foregoing arrangements of the present invention, it is possible to prevent waste of standby power consumption without changing the outer size of an illumination device, by notifying a user that standby power is being consumed.

### BRIEF DESCRIPTION OF DRAWINGS

FIG. 1 is an external view of an illumination device in accordance with an embodiment of the present invention.

FIG. 2 is an exploded perspective view of a main part of the illumination device.

FIG. 3 is a cross-sectional view of the illumination device.

FIG. 4 is a plan view illustrating an example of a configuration of a light-emitting surface of a light source module provided in the illumination device.

FIG. 5 is a block diagram showing how a control section provided in the illumination device is arranged.

FIG. 6 is a flowchart showing an operation of the illumination device.

FIG. 7 is a flowchart showing another operation of the illumination device.

FIG. 8 is a flowchart showing a further operation of the illumination device.

FIG. 9 is a flowchart showing still a further operation of the illumination device.

FIG. 10 is a flowchart showing still yet a further operation of the illumination device.

FIG. 11 is a flowchart showing still yet another operation of the illumination device.

### DESCRIPTION OF EMBODIMENTS

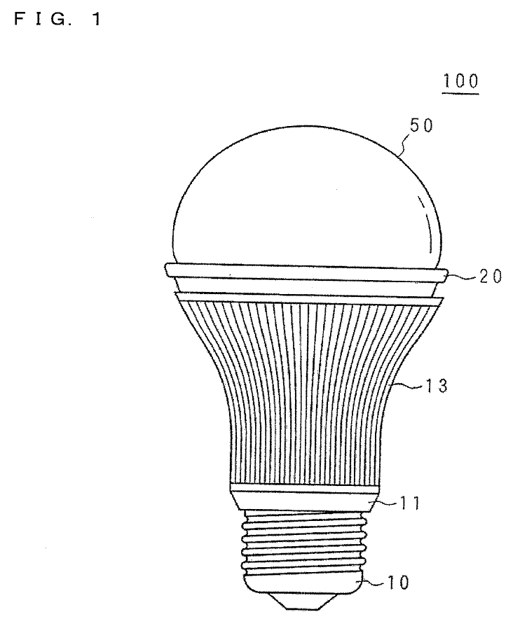

The following description discusses the present invention with reference to the drawings which illustrate embodiments of the present invention. FIG. 1 is an external view of an illumination device 100.

As described in FIG. 1, the illumination device 100 is an LED bulb in the shape of a bulb, and includes (i) a base 10 serving as a power supply connection section to be electrically connected with a commercial power supply by being fitted to an external socket, (ii) a heat dissipation section 13, (iii) a connector 11 which connects the base 10 and the heat dissipation section 13, (iv) a hollow light transmission section 50 in the shape of an approximate hemispherical shell and (v) a disc-like heat dissipation plate 20 on which LED modules (described later) are provided and which is thermally connected with the heat dissipation section 13.

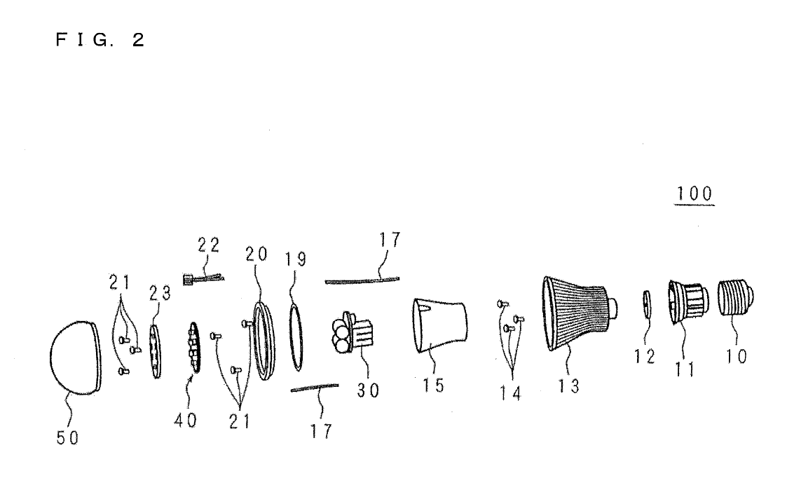

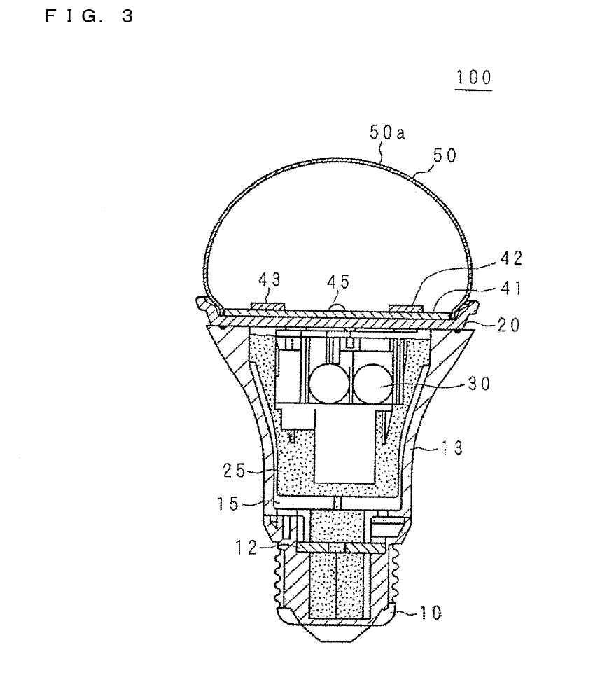

FIG. 2 is an exploded perspective view of a main part of the illumination device 100, and FIG. 3 is a cross-sectional view of the illumination device 100. As illustrated in the FIGS. 2 and 3, a light source module 40 is attached to the heat dissipation plate 20 with screws 21. The light source module 40 is constituted by (i) LED modules 42 and 43 and (ii) a substrate 41 on the surface of which the LED modules 42 and 43 are mounted. The LED modules 42 are capable of emitting for example white light. The LED modules 43 are capable of emitting warm-white light. Note that the colors of light to be emitted are not limited to these colors, and therefore can be other colors such as red, green and/or blue. The substrate 41 includes, in the middle of its surface, a remote control light receiving section 45 which receives a signal from a remote control device such as a remote control. By providing a thermally conductive sheet or applying a high thermal conductive resin between the light source module 40 and the heat dissipation plate 20 so as to improve thermal conduction efficiency, it is possible to allow heat generated in the light source module 40 to escape to the outside through the heat dissipation plate 20 and the heat dissipation section 13.

The heat dissipation section 13 is made of for example a light-weight, high-thermal-conductive metal such as aluminum, and is in the shape of an approximate cylinder. Moreover, the heat dissipation section 13 has a plurality of heat dissipation grooves on its circumference surface so that heat transferred from the light source module 40 to the heat dissipation section 13 is outputted through the circumference surface by utilizing the heat dissipation grooves. Note that, between the heat dissipation section 13 and the heat dissipation plate 20, there is provided a waterproofing packing 19 made of synthetic rubber so that water is prevented from entering the illumination device 100.

The heat dissipation section 13 has a hollow space therein, in which space there are provided (i) a control section 30 for supplying necessary power (voltage and electric current) to the LED modules 42 and 43 of the light source 40 via wires 22 and (ii) a container 15 for containing the control section 30. Between the control section 30 and the base 10, there are provided power supply wires 17 for supplying commercial power to the control section 30.

Between the heat dissipation section 13 and the connector 11, there is provided a waterproofing ring 12 made of synthetic rubber so that water is prevented from entering the illumination device 100. The heat dissipation section 13 and the connector 11 are fixed together with screws 14.

In addition, as illustrated in FIG. 3, the container 15 is filled with a synthetic resin 25 having a high conductivity (for example, polyurethane resin) so that the control section 30 contained in the container 15 is surrounded by the synthetic resin 25 and that heat generated in the control section 30 is transferred to the heat dissipation section 13 and the base 10 efficiently. It is preferable that the synthetic resin 25 has high electric insulating property, low water permeability and incombustibility.

The synthetic resin 25 is fed into the heat dissipation section 13, after electric wiring inside the heat dissipation section 13 is prepared and the heat dissipation section 13 and the base 10 are joined to each other mechanically. Note that the synthetic resin 25 is in liquid state when it is fed. After the heat dissipation section 13 is filled with the synthetic resin 25, the synthetic resin 25 is cured at a necessary temperature. The synthetic resin 25 thus cured adheres to the inner surface of the base 10 and also adheres to the inner surface of the heat dissipation section 13. This makes it possible to further ensure that water does not enter the illumination device 100 through a portion where the base 10 is joined.

Since the synthetic resin 25 has high electric insulation property, it is also possible to ensure that a breakdown and a short circuit do not occur between the heat dissipation section 13 and a charge part of the control section 30. Furthermore, since the synthetic resin 25 has high thermal conductivity, heat generated in the control section escapes not only from the heat dissipation section 13 but also from the base 10 which is thermally connected to the heat dissipation section 13 via the synthetic resin 25. This suppresses an increase in temperature of the control section 30, thereby making it possible to improve reliability of electric parts in the control section 30.

On the light emitting surface of the light source module 40, a reflective plate 23 is attached with screws 21. The reflective plate 23 has, in positions corresponding to the LED modules 42 and 43, through holes which are about the same size as the LED modules 42 and 43. This makes it possible to attach the reflective plate 23 so that the LED modules 42 and 43 are exposed in the through holes. Note that the reflective plate 23 is not essential.

The light transmission section 50 is made of milk-white glass and is fixed to the heat dissipation plate 20 with an adhesive. Note that the material for the light transmission section 50 is not limited to glass, and therefore can be for example a milk-white polycarbonate resin. In a case where the light transmission section 50 is made of a polycarbonate resin, the light transmission section 50 can be screwed and fixed to the heat dissipation plate 20 by cutting a screw thread.

The light transmission section 50 contains a light diffuser 50a for diffusing light from the LED modules 42 and 43 (light source module 40). The light diffuser 50a has for example a crystal structure. The optical properties of the light diffuser 50a are not limited, provided that the light diffuser 50a has a high refractive index, a low light absorbing power and a high light scattering power. For example, the light diffuser 50a can be a pigment having a crystal structure such as a fluorescent substance. As to the proportion of the light diffuser 50a, for example, about a few percent is large enough. The fluorescent substance can be for example 3Ca₃(PO₄)₂Ca(F,Cl)₂SbMn.

The above arrangement achieves the following. Assume that light sources used are the LED modules 42 and 43 each of which has a property of emitting light in the form of plane emission. Even in a case where light from the LED modules 42 and 43 has a strong directional orientation, the light is diffused by the light diffuser 50a when it passes through the light transmission section 50. This makes it possible to obtain wide light distribution with a simple configuration. Note that, in a case where the light diffuser 50a is a fluorescent substance, the fluorescent substance can be a material that diffuses light and also emits light upon excitation by the light. Since the light diffuser 50a itself emits light, it is possible to obtain wider light distribution.

Further, since the light transmission section 50 is hollow and in the shape of an approximate hemispherical shell, it is possible to provide an illumination device in the shape of a bulb which uses the LED modules 42 and 43 (light-emitting diodes) and has wide light distribution.

In particular, the above arrangement achieves the following. That is, the light transmission section 50 is joined to the heat dissipation plate 20 at a portion where the diameter of the light transmission section 50 is a little smaller than the maximum diameter of the light transmission section 50 in the shape of an approximate hemispherical shell. Therefore, light emitted from the LED modules 42 and 43 passes also through a part, of the surface of the light transmission section 50, which extends from a portion where the light transmission section 50 and the dissipation plate 20 are joined to the maximum-diameter portion. This allows the light to be emitted in a direction from the heat dissipation section 13 to the base 10, and thus possible to obtain wider light distribution.

According to the foregoing example shown in FIG. 3, the light diffuser 50a is contained in the light transmission section 50. Note, however, that this does not imply any limitation. A light diffuser can be applied to the light transmission section 50.

The illumination device 100 described above is constituted by an LED bulb which emits light of specified colors. The illumination device 100 has a brightness control function.

The illumination device 100 has a function of controlling, with use of a remote control for remote operation, not only brightness but also colors of light (i.e., controlling the color of light to a desired color).

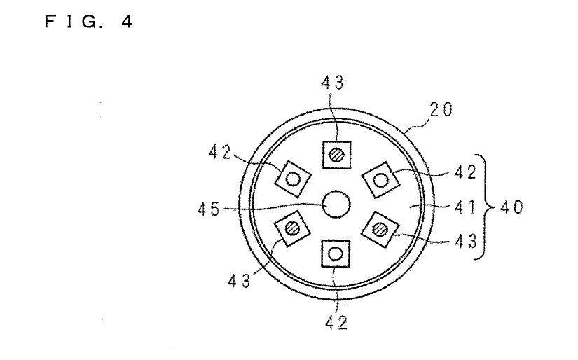

FIG. 4 is a plan view showing an example of a structure of a light-emitting surface of the light source module 40.

The light source module 40 is constituted by (i) the substrate 41 which is in the shape of an approximate circle and made of an aluminum alloy or the like and (ii) a plurality of LED modules 42 and 43 which emit different colors of light and are arranged alternately in a circle at regular intervals. In the example shown in FIG. 4, three LED modules 42 and three LED modules 43 are provided. Note, however, that the number of and how to arrange the LED modules 42 and 43 are not limited to the example shown in FIG. 4. Therefore, for example the number of LED modules can be appropriately changed and the LED modules can be arranged in a rectangle depending on the specifications and purposes of the illumination device. Note that the substrate 41 can be made of a ceramic or the like.

The substrate 41 in the shape of an approximate circle has the remote control light receiving section 45 in the middle thereof. As is clear from FIG. 3, when the illumination device 100 in the shape of a bulb is attached to a lighting apparatus etc., what is seen from outside is almost only the light transmission section 50. For example, in order for a user to carry out a remote operation via a remote control, the remote control light receiving section 45 needs to be provided within an area which is seen from the user as the light transmission section 50. Under such circumstances, arranging the LED modules 42 and 43 so that the LED modules 42 and 43 surrounds the remote control light receiving section 45 makes it possible to reduce the size of the illumination device 100.

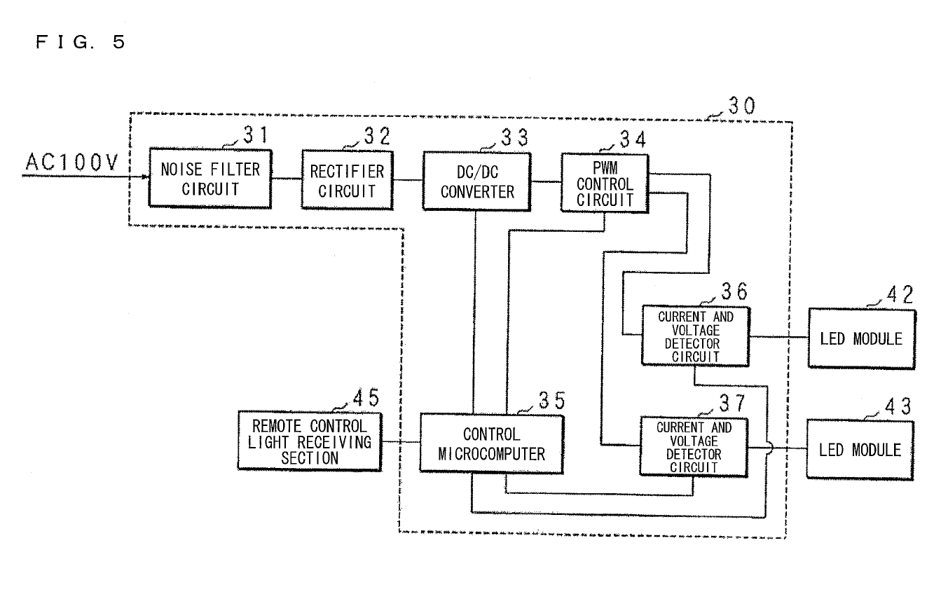

FIG. 5 is a block diagram showing a configuration of the control section 30 of the illumination device 100. The control section 30 includes (i) a noise filter circuit 31 for removing noise coming from a commercial power supply etc., (ii) a rectifier circuit 32 for rectifying an AC voltage to thereby convert the AC voltage into a DC voltage, (iii) a DC/DC converter 33 for converting the DC voltage outputted from the rectifier circuit 32 into a desired DC voltage, (iv) a PWM control circuit 34 for controlling, by modulating a pulse width of the DC voltage outputted from the DC/DC converter 33, an electric current to be supplied to the LED modules 42 and 43, (v) a control microcomputer 35 for controlling the control section 30, (vi) a current and voltage detector circuit 36 for detecting an electric current passing through the LED modules 42 and a voltage applied to the LED modules 42, and (vii) a current and voltage detector circuit 37 for detecting an electric current passing through the LED modules 43 and a voltage applied to the LED modules 43, and the like.

The remote control light receiving section 45 (i) receives an infrared ray from an infrared LED which is contained in a remote control that a user operates, (ii) extracts a signal sent from the remote control and (iii) supplies the extracted signal to the control microcomputer 35. The signal sent from the remote control is for example a signal for turning on or off a light source, controlling brightness (for example, 70%, 50%, 30%) of light, and/or controlling the color of light (for example, gradually changing the color of light from white to warm white).

Prior to describing an operation of the illumination device, the following description discuses standby power.

For example, power consumption of an LED bulb is 7.5 W, and standby power consumption while the LED bulb is in an OFF state (the LED bulb was turned off by a remote control) is approximately 0.6 W. That is, the standby power consumption of the LED bulb is approximately 8% of the power consumption during the LED bulb is in the ON state. Note that, in a case where the LED bulb is turned off with use of a wall switch, no standby power is consumed because a power supply to the LED bulb is cut off. In a case where the LED bulb is turned off by operation of a remote control and is in the OFF state for a long time for example during the daytime or when a user is away from home, the standby power is unnecessarily consumed. Therefore, it is preferable to take measures to reduce such standby power consumption.

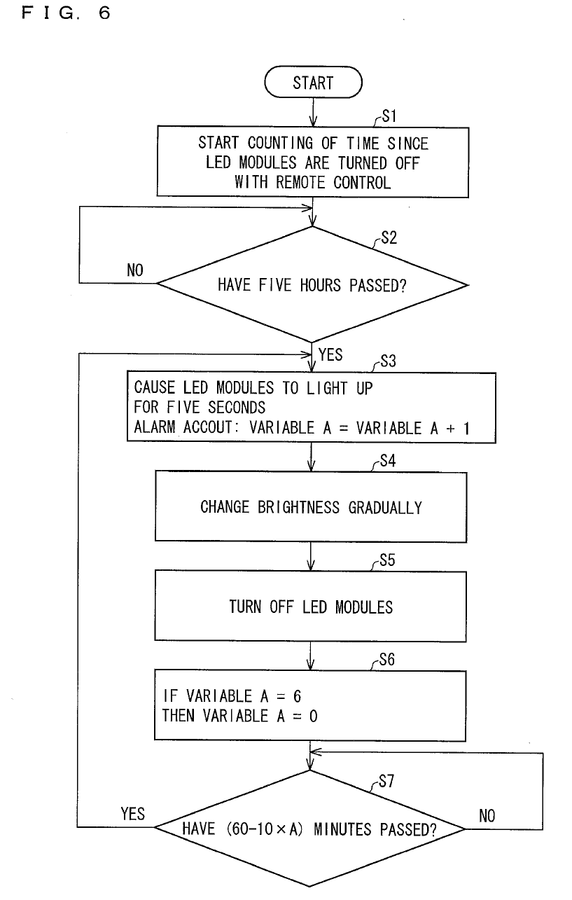

However, if a receiving section and a controlling device for dramatically reducing standby power consumption of a microcomputer are to be provided inside an LED bulb, the following problem occurs. That is, a much larger LED bulb is required, and thus the appearance of the LED bulb is spoiled and the LED bulb cannot be used practically because for example the LED bulb cannot be fitted in a bulb cover. In view of the circumstances, it is possible to consider employing the following arrangement. In a case where for example a liquid crystal television is turned off by operation of a remote control, an LED etc. serving as a power indicator lamp lights up in red or the like color while the liquid crystal television is in a standby state. Similarly to this, one LED inside the LED bulb can be lit up. However, in this case, the light diffuser 50a entirely diffuses light emitted from the LED. This reduces the brightness of the LED itself, and a user will have difficulty in recognizing the light from the LED. In order for the user to recognize the light even in bright daylight, for example it is preferable to have a brightness equivalent to or greater than that of a 40-watt incandescent lamp. However, it is difficult for the user to recognize the light from the LED by lighting up only one LED. In view of this, the following description discusses, with reference to FIGS. 5 and 6, a configuration to notify a user of the standby power consumption without additional parts or the like, which configuration is made in consideration of the above problems.

FIG. 6 is a flowchart showing an operation of the illumination device. In Step S1, the control microcomputer 35 recognizes that the remote control light receiving section 45 (see FIGS. 3 to 5) has received a turn-off instruction signal, which indicates “turning off the illumination device with use of a remote control”. Then, the control microcomputer 35 turns off the LED modules 42 and 43 and, at the same time, starts “counting of time since the LED modules are turned off”. In Step S2, the control microcomputer 35 checks for example “whether five hours have passed”. If the control microcomputer 35 has determined that the counted time has not reached five hours (NO in Step S2), the process goes back to Step S2 until the counted time reaches five hours. If the control microcomputer 35 has determined that the counted time has reached five hours (YES in Step S2), the process proceeds to Step 3. In Step S3, the control microcomputer 35 causes the LED module 42 and 43 to light up for five seconds. This serves as “an alarm to notify a user that the illumination device was turned off by a remote control, and therefore standby power is being consumed”. At the same time, the control microcomputer 35 increments an alarm account (variable A=variable A+1) (Step 3). Note that the initial value of the variable A is 0.

Next, in Step S4, the control microcomputer 35 “gradually changes brightness” of the LED modules 42 and 43 (S4).

Next, in Step S5, the control microcomputer 35 “turns off” the LED modules 42 and 43.

This series of processes makes it possible to notify a user that “the illumination device was turned off by a remote control, i.e., the illumination device is in a standby state, and thus standby power is being consumed”. From this notification, the user notices that standby power is being consumed, and can turn off a main power source such as a wall switch to thereby stop the standby power consumption. This prevents unnecessary consumption of standby power.

Alternatively, it is possible to allow the standby power to continue to be consumed, in the following manner. By providing a switch for retaining the standby state in an operation section of a remote control and operating the switch, a retention signal for retaining the standby state (signal for allowing the standby power to continue to be consumed) is transmitted from a transmitting section of the remote control to the remote control light receiving section 45. In response to the signal from the remote control light receiving section 45, the control microcomputer 35 retains the standby state without lighting up the LED modules 42 and 43, even after five hours have passed since the LED modules 42 and 43 were turned off as shown in the flowchart of FIG. 6.

An illumination system is constituted by (i) the illumination device 100 including: the remote control light receiving section 45 which receives a signal from a remote control device and transmits the signal to the control section 30; the light sources (LED modules 42 and 43); and the control section 30 and (ii) the remote control device (remote control).

The “continuation of standby state” can be selected by a user for example by (i) operating a switch for keeping the standby state or (ii) holding down an “ON” switch etc. of the remote control.

When the illumination device 100 is turned off by a main power switch such as a wall switch, electric power stops being supplied to the illumination device 100. Therefore, when the illumination device 100 is turned on again by the wall switch, the control microcomputer 35 is reset and operates in an initial state, In a case where the “continuation of standby state” is not selected when the illumination device 100 is turned off by the remote control, the process starts again from Step S1 shown in FIG. 6.

Next, in Step S6 in the flowchart, when the variable A of the alarm account becomes 6, the control microcomputer 35 returns the variable A to 0. After that, in Step S7, the control microcomputer determines whether “(60-10×A) minutes have passed”. The control microcomputer 35 repeats Step S7 until (60-10×A) minutes have passed. If the control microcomputer 35 has determined that (60-10×A) minutes have passed, the process goes back to Step S3, and is repeated from Step S3.

That is, a period of time from when the LED modules 42 and 43 are turned off in Step S5 to when the LED modules 42 and 43 are lit up in Step S3 becomes shorter in the order of 50 minutes, 40 minutes, 30 minutes, 20 minutes and 10 minutes, increases to 60 minutes, and then becomes 50 minutes. This cycle is repeated. As a specific example, in a case where A=1 in Step S7, the process goes back to Step S3 after 50 minutes have passed. In a case where A=5, the process goes back to Step S3 after 10 minutes have passed. In a case where A=6 in Step S6, the variable A is reset to 0. Therefore, the process goes back to Step S3 after 60 minutes have passed in Step S7. Then, the period of time to when the LED modules 42 and 43 are lit up is again changed in the order of 50 minutes, 40 minutes, 30 minutes, 20 minutes, and 10 minutes.

Note that, although the LED modules 42 and 43 light up in Step S3 in the foregoing description, the LED modules 42 and 43 can brink. Alternatively, for example, it is possible to employ a combination of one or more lightings and one or more blinkings.

Note that, although it is determined in Step S2 that whether “five hours have passed”, the five hours is an example and thus this does not imply any limitation. For example, the time can be short (e.g., 15 minutes) or can be 10 hours.

Although “the LED modules 42 and 43 light up for five seconds” in Step S3, the five seconds is an example and thus this does not imply any limitation. For example, the LED modules 42 and 43 can light up for 10 seconds or 60 seconds.

Note that, although the variable A is reset to 0 when it becomes 6 in Step S6, this does not imply any limitation. The variable A can be reset to 0 when it becomes 5. A threshold of the variable A here is not limited provided that it is an integer not less than 1 but not more than 5. Moreover, although it is determined in Step 7 whether “(60-10×A) minutes have passed”, the number 60 can be replaced with a number larger than 60 or a number smaller than 60. Although the control microcomputer 35 “gradually changes brightness” in the foregoing Step S4, the brightness can be changed not gradually but instantly. Alternatively, the brightness can be changed gradually in one cycle and instantly in another cycle.

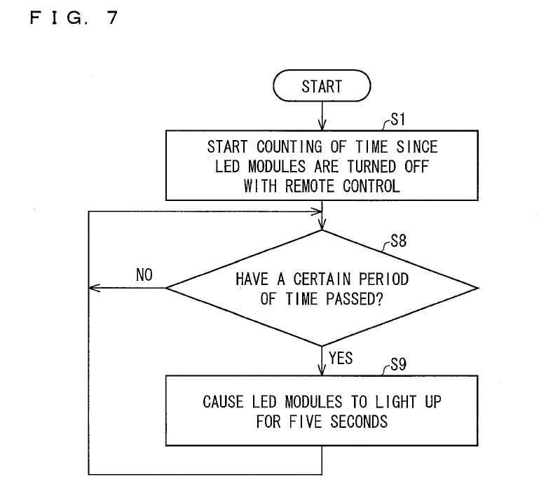

For example in a bedroom, too bright lighting disturbs a user's sleep. In view of this, provision of functions of “controlling brightness”, “controlling color” and “continuing standby state” to a remote control improves conveniences. Note that, as to blinking, in Step S4, the LED modules 42 and 43 can be blinked with its brightness gradually changed. Alternatively, the number of blinkings can be changed without a change in the brightness, intervals between blinkings can be changed, and/or colors can be changed. Further, by providing a function of lighting up the LED modules 42 and 43 at regular intervals (e.g., every 15 minutes, every 30 minutes, every 1 hour or every 2 hours), it is possible for a user to know how long time has passed. In this way, the illumination device 100 serves as a timer or a clock. Alternatively, for example, the illumination device 100 can be arranged to repeat five-second lighting at one-hour intervals similarly to a time signal, by using a time counting function of the control microcomputer 35. FIG. 7 is a flowchart of another operation of the illumination device 100. In Step S1, the control microcomputer 35 recognizes that the remote control light receiving section 45 (see FIGS. 3, 4 and 5) has received a turn-off instruction signal, which indicates “turning off the illumination device 100 with use of a remote control”. Then, the control microcomputer 35 turns off the LED modules 42 and 43 and, at the same time, starts “counting of time since the LED modules 42 and 43 are turned off”. In Step S8, the control microcomputer 35 checks “whether a certain period of time has passed”. If the control microcomputer 35 has determined that the certain period of time has not been passed (NO in Step S8), Step S8 is repeated until the certain period of time has passed. If the control microcomputer 35 has determined that the certain period of time has passed (YES in Step S8), the control microcomputer 35 causes the LED modules 42 and 43 to light up for a period of time (e.g., five seconds) (Step S9). Then, the process returns to Step S8. The certain period of time as in the “whether a certain period of time has passed” in Step S8 is for example 15 minutes, 30 minutes, 1 hour or 2 hours as described earlier. In this case, for example, a switch for “repeating lighting” can be provided on an operation section of a remote control or an “ON” switch etc. can be pressed and held down Note that the above example does not imply any limitation. The LED modules 42 and 43 can be lit up for a certain period of time at regular intervals.

The light control function of the illumination device 100 can be provided separately. The illumination device 100 can be arranged such that (i) a light controller (not illustrated) is provided to a power line between a commercial power supply and the illumination device 100 and (ii) the brightness of the illumination device 100 is controlled by the light controller. How a color is controlled is described below.

In a case where the control microcomputer 35 receives, via the remote control light receiving section 45, an operation to change an illumination color (i.e., color of light emitted from the illumination device 100 as a whole) to white, the control microcomputer 35 lights up a white LED module (LED modules 42) with a duty ratio of 100% and turns off a warm-white LED module (LED modules 43).

In a case where the control microcomputer 35 receives, via the remote control light receiving section 45, an operation to change an illumination color (e.g., color of light emitted from the illumination device 100 as a whole) to a little warmer white from white, the control microcomputer 35 lights up a white LED module (LED modules 42) with a duty ratio of 75% and lights up a warm-white LED module (LED modules 43) with a duty ratio of 25%. The duty ratio is the proportion of a period during which an electric current is supplied to an LED module to one cycle. Under this condition, the illumination color is a color between white and neutral white.

In a case where the control microcomputer 35 receives, via the remote control light receiving section 45, an operation to change an illumination color (e.g., color of light emitted from the illumination device 100 as a whole) to neutral white, the control microcomputer 35 lights up a white LED module (LED modules 42) with a duty ratio of 50% and lights up a warm-white LED module (LED modules 43) with a duty ratio of 50%. Under this condition, the illumination color is neutral white.

In a case where the control microcomputer 35 receives, via the remote control light receiving section 45, an operation to change an illumination color (e.g., color of light emitted from the illumination device 100 as a whole) to a little warmer white from neutral white, the control microcomputer 35 lights up a white LED module (LED modules 42) with a duty ratio of 25% and lights up a warm-white LED module (LED modules 43) with a duty ratio of 75%. Under this condition, the illumination color is a color between neutral white and warm white.

In a case where the control microcomputer 35 receives, via the remote control light receiving section 45, an operation to change an illumination color (e.g., color of light emitted from the illumination device 100 as a whole) to warm white, the control microcomputer 35 turns off a white LED module (LED modules 42) and lights up a warm-white LED module (LED modules 43) with a duty ratio of 100%. Under this condition, the illumination color is warm white.

The control microcomputer 35 controls the LED modules 42 and 43 so that the LED modules 42 and 43 which emit different colors of light do not light up simultaneously (so that periods of time during which the respective LED modules 42 and 43 are ON, i.e., periods of PWM control, do not overlap). In other words, the control microcomputer 35 turns off a warm-white LED module while a white LED module is ON, and turns off the white LED module while the warm-white LED module is ON. This makes it possible to control the color of emitted light, without increasing an electric current supplied to the LED modules 42 and 43 to a set value (a value of an electric current supplied to an LED module which emits one of the different colors) or greater.

In addition, the PWM control makes it possible to change the proportions of periods during which the respective LED modules of different colors are ON, thereby changing the illumination color to a desired color (color temperature) such as white, neutral white or warm white. This makes it possible to realize a light environment most suitable for a scene where the illumination device is used and for the user's tastes.

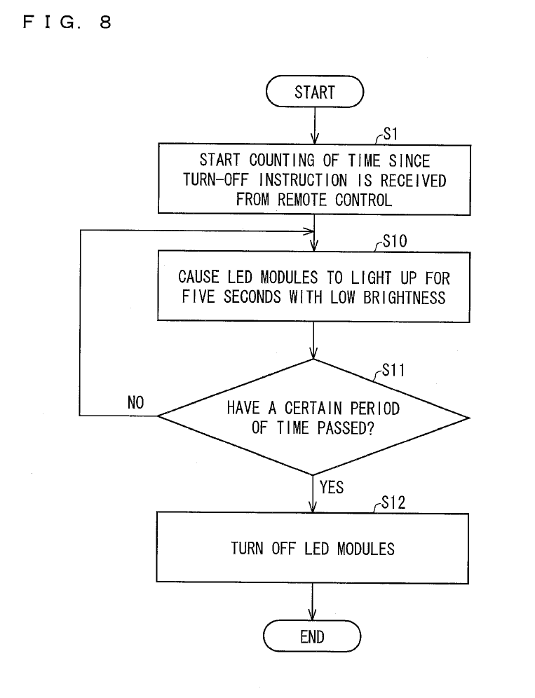

FIG. 8 is a flowchart showing a further operation of the illumination device 100. The illumination device 100 can be arranged such that, after receiving a turn-off instruction signal generated by operation of the remote control, the control microcomputer 35 causes the LED modules 42 and 43 to light up with a low brightness for a period of time (e.g., five seconds) and then turn off. First, in Step S1, the control microcomputer 35 recognizes that the remote control light receiving section 45 (see FIGS. 3, 4 and 5) has received a turn-off instruction signal, which indicates “turning off the illumination device 100 with use of a remote control”. Then, the control microcomputer 35 starts “counting of time since the turn-off instruction signal was received”. Then, in Step S10, the control microcomputer 35 causes LED module 42 and 43 to light up with a low brightness. Then, in Step S11, the control microcomputer 35 determines whether the counted time has reached a certain period of time. If the control microcomputer 35 has determined that the counted time has not reached the certain period of time (NO in Step S11), Step S10 and Step S11 are repeated until the counted time reaches the certain period of time. If the control microcomputer 35 has determined that the counted time has reached the certain period of time (YES in Step S11), the control microcomputer 35 turns off the LED module 42 and 43 in Step S12 and the process ends.

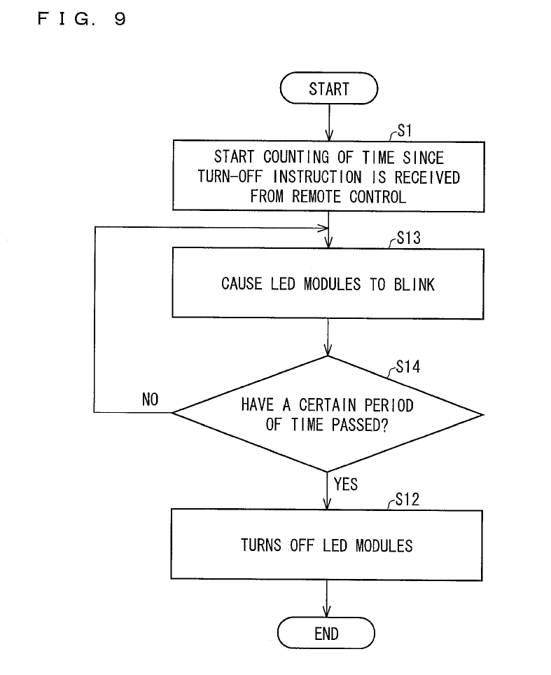

FIG. 9 is a flowchart showing still a further operation of the illumination device 100. The illumination device 100 can be arranged such that, after receiving a turn-off instruction signal generated by operation of the remote control, the control microcomputer 35 causes the LED modules 42 and 43 to brink for a certain period of time and then turn off. First, in Step S1, the control microcomputer 35 recognizes that the remote control light receiving section 45 (see FIGS. 3, 4 and 5) has received a turn-off instruction signal. Then, the control microcomputer 35 starts “counting of time since the turn-off instruction signal was received”. Then, in Step S13, the control microcomputer 35 causes the LED modules 42 and 43 to blink. Then, in Step S14, the control microcomputer 35 determines whether the counted time has reached a certain period of time. If the control microcomputer has determined that the counted time has not reached the certain period of time (NO in Step S14), Step S13 and Step S14 are repeated until the counted time reaches the certain period of time. If the control microcomputer 35 has determined that the counted time has reached the certain period of time (YES in Step S14), the control microcomputer 35 turns off the LED modules 42 and 43 in Step S12, and the process ends.

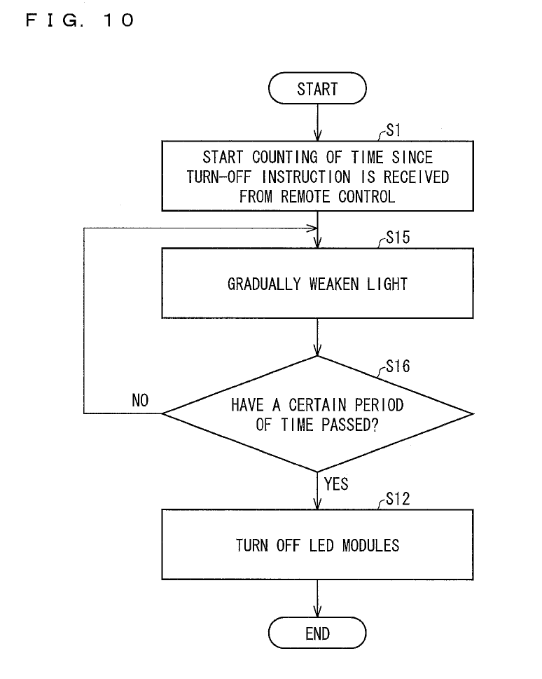

FIG. 10 is a flowchart showing still yet a further operation of the illumination device 100. The illumination device 100 can be arranged such that the control microcomputer 35 turns off the LED modules 42 and 43 while gradually weakening light over a certain period of time. First, in Step S1, the control microcomputer 35 recognizes that the remote control light receiving section 45 has received a turn-off instruction signal. Then, the control microcomputer 35 starts “counting of time since the turn-off instruction signal was received”. Then, in Step S15, the control microcomputer 35 gradually weakens light from the LED modules 42 and 43. Next, in Step S16, the control microcomputer 35 determines whether the counted time has reached a certain period of time. If the control microcomputer has determined that the counted time has not reached the certain period of time (NO in Step S16), Step S15 and Step S16 are repeated until the counted time reaches the certain period of time. If the control microcomputer 35 has determined that the counted time has reached the certain period of time (YES in Step S16), the control microcomputer 35 turns off the LED modules 42 and 43 in Step S12, and the process ends.

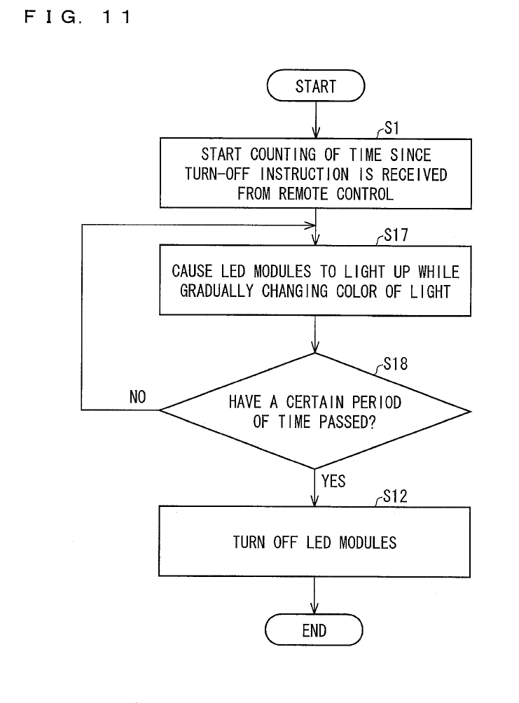

FIG. 11 is a flowchart showing still yet another operation of the illumination device 100. The illumination device 100 can be arranged such that the control microcomputer 35 turns off the LED modules 42 and 43 while gradually changing colors of light over a certain period of time. Alternatively it is possible to employ a combination of gradual controlling colors. First, in Step S1, the control microcomputer 35 recognizes that the remote control light receiving section 45 has received a turn-off instruction signal. Then, the control microcomputer 35 starts “counting of time since the LED modules are turned off”. Then, in Step S17, the control microcomputer 35 causes the LED modules 42 and 43 to light up while gradually changing colors of light. Next, in Step S18, the control microcomputer 35 determines whether the counted time has reached a certain period of time. If the control microcomputer 35 has determined that the counted time has not reached the certain period of time (NO in Step S18), Step S17 and Step S18 are repeated until the counted time reaches the certain period of time. If the control microcomputer 35 has determined that the counted time has reached the certain period of time (YES in Step S18), the control microcomputer 35 turns off the LED modules 42 and 43 in Step S12, and the process ends.

In the manner as has been described, it is possible to quickly inform a user that the illumination device 100 was turned off by a remote controller and is in a standby state, and that standby power is being consumed. Once the user noticed that the standby power is being consumed, the user can voluntarily turn off the main power supply via a wall switch, when for example the user goes to bed or leaves a room for a long time to go out. This makes it possible to save energy.

Further, by retaining the standby state by selecting the “continuation of standby state” via a switch of the remote controller, the following can be achieved. For example in a case where a user sleeps in a bedroom, the control microcomputer 35 repeatedly carries out Steps S3 to S7 while the user is sleeping, to thereby cause the LED modules 42 and 43 to light up intermittently. This does not disturb the user's sleep.

The “notifying means” recited in claims corresponds to the control microcomputer 35 shown in FIG. 5, and carries out Steps S3 to S5 shown in FIG. 6 and repeatedly carries out Steps S3 to S7 shown in FIG. 6. Note that, although the present embodiment discussed an example in which the notifying means makes a notification by causing light sources to light up or blink for a predetermined period, the present invention is not limited to this embodiment. The notifying means can notify a user, by means of sound, that the power supply is in a standby state.

Although the foregoing embodiment discussed an illumination device in the shape of a bulb, the shape of the illumination device is not limited to the shape of a bulb. The illumination device can be in other shapes. Further, although the foregoing embodiment discussed an illumination device including an LED module as a light source, the light source is not limited to the LED module. The light source can be other light sources such as an organic EL (electroluminescence), provided that the light configured to emit light in the form of plane emission or which has a configuration equivalent thereto. Alternatively, the light source can be constituted by a combination of these light sources.

As has been described, since the illumination device is configured to cause a user to recognize that standby power is being consumed, it is unnecessary to provide an additional member outside the illumination device like a configuration of a conventional technique. Further, the illumination device 100, which is a bulb or the like, can be removed easily from an external fitting part (for example, a socket). Therefore, it is possible to easily use a function of notifying that the standby power is being consumed, by simply replacing an illumination device with the illumination device 100.

The remote control device can either be (i) the one that transmits a signal to and receives a signal from a main body of the illumination device via a wire or (ii) the one that transmits a signal to and receives a signal from the main body of the illumination device by radio. The remote control device can be recessed in a wall or attached to the wall.

The illumination device in accordance with the present invention is preferably arranged such that, after the certain period of time has passed since the light source was turned off, the control section causes the light source to light up or blink for a set period of time according to a predetermined pattern.

According to the arrangement, it is possible to notify a user, by means of light, that a power supply is in a standby state.

The illumination device in accordance with the present invention can be arranged such that the notifying means causes the light source to light up or blink for a predetermined period of time.

According to the arrangement, it is possible to notify a user, by means of lighting or blinking of the light source, that standby power is being consumed.

The illumination device in accordance with the present invention is preferably arranged such that the notifying means gradually changes brightness of the light source each time the notifying means causes the light source to light up or blink.

According to the arrangement, it is possible to easily notify a user, by a pattern of lighting up or blinking the light source and thereafter gradually changing the brightness of the light source, that the power supply is in a standby state.

The illumination device in accordance with the present invention is preferably arranged such that the notifying means causes the light source to light up or blink at intervals that change according to a predetermined type.

According to the arrangement, it is possible to easily notify a user, by a pattern of lighting up or blinking the light source at intervals of for example 60 minutes, 50 minutes, 40 minutes, 30 minutes, 20 minutes or 10 minutes, that the power supply is in a standby state.

The illumination device in accordance with the present invention is preferably arranged such the control section gradually changes brightness of the light source each time the control section causes the light source to light up or blink.

According to the arrangement, it is possible to easily notify a user, by a pattern of lighting up or blinking the light source and thereafter gradually changing the brightness of the light source, that the power supply is in a standby state.

The illumination device in accordance with the present invention is preferably arranged such the control section causes the light source to light up or blink at intervals that change according to a predetermined type.

According to the arrangement, it is possible to easily notify a user, by a pattern of lighting up or blinking the light source at intervals that change according to a predetermined type, that the power supply is in a standby state.

The illumination device in accordance with the present invention is preferably arranged such that the illumination device is a bulb; and the receiving section and the control section are provided in the bulb.

According to the arrangement, since the receiving section and the control section are provided inside the bulb, it is possible to reduce standby power by simply replacing a bulb without increasing the size of a conventional bulb.

The illumination device in accordance with the present invention is preferably arranged such that the light bulb is an LED bulb.

According to the arrangement, it is possible to reduce a standby current for the illumination device and the illumination system each of which is lit up with use of an LED bulb.

The embodiments discussed in the foregoing description of embodiments serve merely as examples for implementing the present invention, and the present invention is not limited to these embodiments. An embodiment based on a proper combination of technical means disclosed in the foregoing embodiments and a well-known technique is also encompassed in the technical scope of the invention.

The present invention can also be described as below.

An illumination device of the present invention includes a light source, a control section and a receiving section, wherein the receiving section receives a signal from a remote control device and supplies the signal to the control section. The illumination device includes notifying means for notifying a user, after the illumination device is turned off by an operation of the remote control device, that the power supply is in a standby state. The notifying means causes the light source to light up or blink for a set period of time.

An illumination device of the present invention includes a light source, a control section and a receiving section, wherein the receiving section receives a signal from a remote control device and supplies the signal to the control section. The control section receives a turn-off instruction signal from the remote control device, and, after a set period of time has passed, causes the light source to light up or blink for a set period of time.

The illumination device of the present invention is preferably arranged such that the receiving section and the control section are provided inside a bulb.

The illumination device of the present invention is preferably arranged such that the illumination device uses an LED bulb.

An illumination system of the present invention includes a remote control device and an illumination device, wherein: the illumination device includes a light source, a control section and a receiving section; the receiving section receives a signal from the remote control device and supplies the signal to the control section; and the remote control device includes switching means for retaining a standby state and a transmitting section which transmits a signal to retain the standby state, the switching means being provided to an operation section of the remote control device.

The illumination system of the present invention is preferably arranged such that the illumination device uses an LED bulb.

### INDUSTRIAL APPLICABILITY

The present invention is applicable to an illumination device which includes a light source such as an LED, and particularly applicable to an illumination device in the shape of a bulb.

### REFERENCE SIGNS LIST

30 Control section
35 Control microcomputer
40 Light source module
41 Substrate
42, 43 LED module (light source)
45 Remote control light receiving section
50 Light transmission section
100 Illumination device

1-8. (canceled)

9. An illumination device comprising:
a receiving section for receiving, from a remote control device, a turn-off instruction signal which instructs a light source to be turned off; and
a control section for turning off the light source in response to the turn-off instruction signal received by the receiving section and notifying a user that a power supply is in a standby state.

10. The illumination device of claim 9, wherein the control section notifies the user, after a certain period of time has passed since the light source was turned off, that the power supply is in the standby state.

11. The illumination device of claim 10, wherein, after the certain period of time has passed since the light source was turned off, the control section causes the light source to light up or blink for a set period of time according to a predetermined pattern.

12. The illumination device of claim 9, wherein the control section gradually changes brightness of the light source each time the control section causes the light source to light up or blink.

13. The illumination device of claim 9, wherein the control section causes the light source to light up or blink at intervals that change according to a predetermined type.

14. The illumination device of claim 9, wherein:
the illumination device is a bulb; and
the receiving section and the control section are provided in the bulb.

15. The illumination device of claim 14, wherein the bulb is an LED bulb.

16. An illumination system comprising:
an illumination device; and
a remote control device,
the illumination device including
a receiving section for receiving a turn-off instruction signal from the remote control device and
a control section for turning off the light source in response to the turn-off instruction signal received by the receiving section and, after a certain period of time has passed, notifying a user that a power supply is in a standby state, and
the remote control device including
switching means provided to retain the standby state of the power supply, and
a transmitting section for transmitting, to the receiving section, a retention signal to retain the standby state of the power supply, in response to operation of the switching means.

17. The illumination system of claim 16, wherein:
the illumination device is a LED bulb.
